(19) United States
(12) Patent Application Publication
(10) Pub. No.: US 2025/0065475 A1
(43) Pub. Date: Feb. 27, 2025

(54) SOCKET

(71) Applicant: YING-MO LIN, Nantou County (TW)

(72) Inventor: YING-MO LIN, Nantou County (TW)

(21) Appl. No.: 18/675,313

(22) Filed: May 28, 2024

(30) Foreign Application Priority Data
Aug. 24, 2023 (TW) 112209056

(51) Int. Cl. B25B 13/06

(52) U.S. Cl. CPC B25B 13/06

(57) ABSTRACT

A socket is provided, wherein the socket includes: a main body defining a circumferential direction, a radial direction and an axial direction, and including an outer wall and grooves, the grooves being disposed on the outer wall and extending in the radial direction, abutting portions each being formed between two neighboring ones of the grooves in the circumferential direction; and a buffer ring sleeved to the outer wall in the axial direction and deformed to be a geometric polygon, the geometric polygon including engaging portions engaged in the grooves and corner portions abutted on the abutting portions. Another socket is provided, wherein the socket includes: a main body including an outer wall; and a geometric polygon, the geometric polygon and the main body being integrally formed of one piece, the geometric polygon projecting from the outer wall.

### BACKGROUND OF THE INVENTION

### Field of the Invention

The present invention relates to a hand tool, and especially to a socket.

### Description of the Prior Art

Sockets are often used to drive objects to be driven to rotate, and can be replaced correspondingly with different types of the objects to be driven. They are often used in processing factories to install/remove fasteners (such as bolts, screws and/or nuts). In practice, a socket is operated in cooperation with a driving tool. For example, the socket is assembled with a wrench or a power tool to provide a larger torque, which is labor-saving.

However, some situations, such as collision or falling, might occur during use. Frequent collisions or excessive impact will cause the socket to be deformed and damaged, and if the socket falls to the ground, the socket will keep rolling, making it difficult for the user to pick it up.

The present invention is, therefore, arisen to obviate or at least mitigate the above-mentioned disadvantages.

### SUMMARY OF THE INVENTION

The main object of the present invention is to provide a socket, which provides the whole protection in a circumferential direction and effectively prevents the socket from rolling on the ground.

To achieve the above and other objects, a socket is provided, wherein the socket includes: a main body defining a circumferential direction, a radial direction and an axial direction, and including an outer wall and a plurality of grooves, the plurality of grooves being disposed on the outer wall and extending in the radial direction, a plurality of abutting portions each being formed between two neighboring ones of the plurality of grooves in the circumferential direction; and a buffer ring sleeved to the outer wall in the axial direction and deformed to be a geometric polygon, the geometric polygon including a plurality of engaging portions and a plurality of corner portions, the plurality of engaging portions being engaged in the plurality of grooves, the plurality of corner portions being abutted on the plurality of abutting portions.

To achieve the above and other objects, another socket is provided, wherein the socket includes: a main body including an outer wall; and a geometric polygon, the geometric polygon and the main body being integrally formed of one piece, the geometric polygon projecting from the outer wall.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a front view in the basis of FIG. 1 of an exemplary embodiment of the present invention;

FIG. 3 is a left view in the basis of FIG. 1 of an exemplary embodiment of the present invention;

FIG. 4 is a cross-sectional view, taken along line A-A in FIG. 2, according to an exemplary embodiment of the present invention;

FIG. 5 is a breakdown drawing of an exemplary embodiment of the present invention;

FIG. 6 is a drawing of a main body of an exemplary embodiment of the present invention;

FIG. 7 is a cross-sectional view, taken along line B-B in FIG. 6, according to an exemplary embodiment of the present invention;

FIG. 8 is a drawing showing the falling situation of a socket of an exemplary embodiment of the present invention; and

FIG. 9 is a stereogram of another exemplary embodiment of the present invention.

### DETAILED DESCRIPTION OF THE PREFERRED EMBODIMENTS

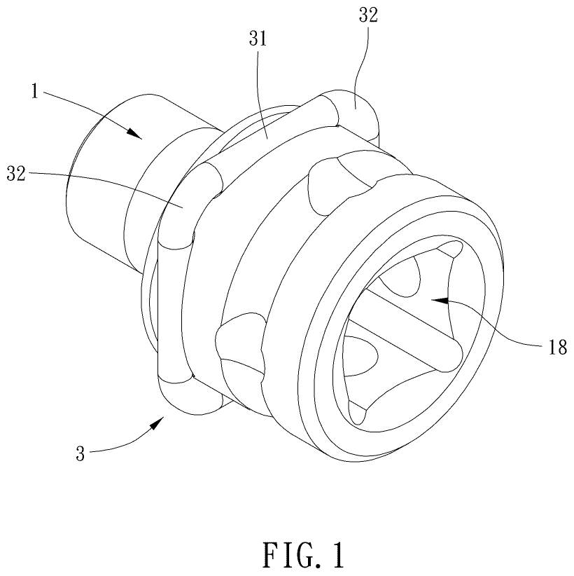

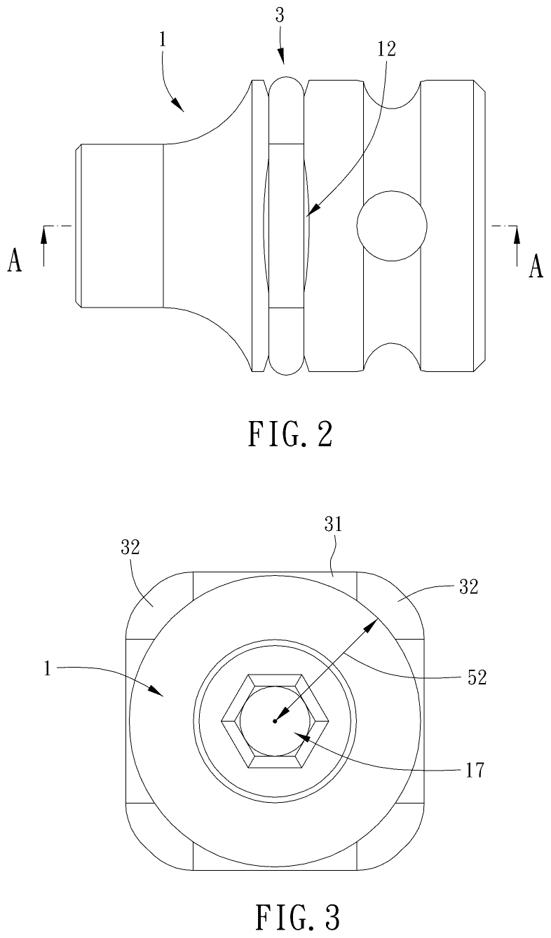

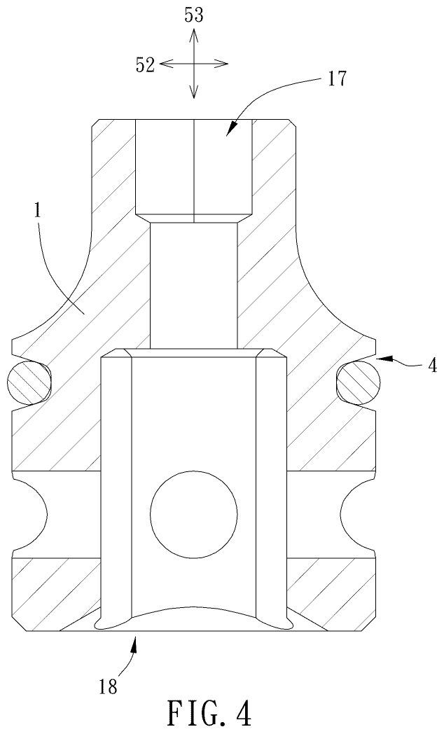

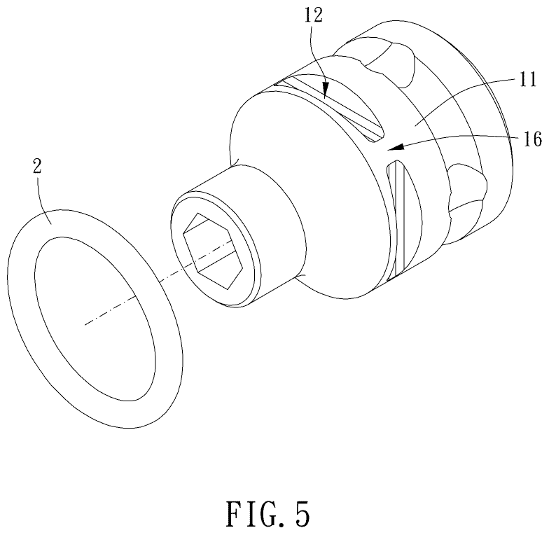

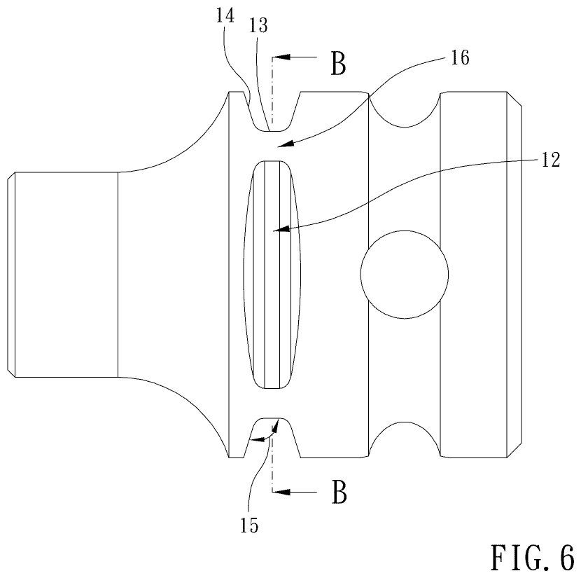

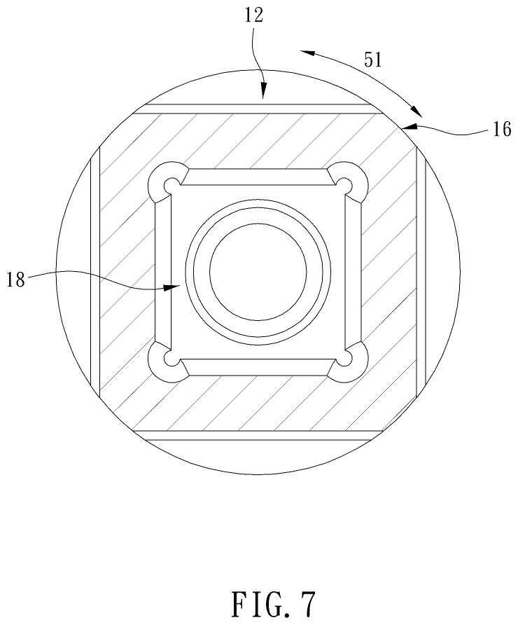

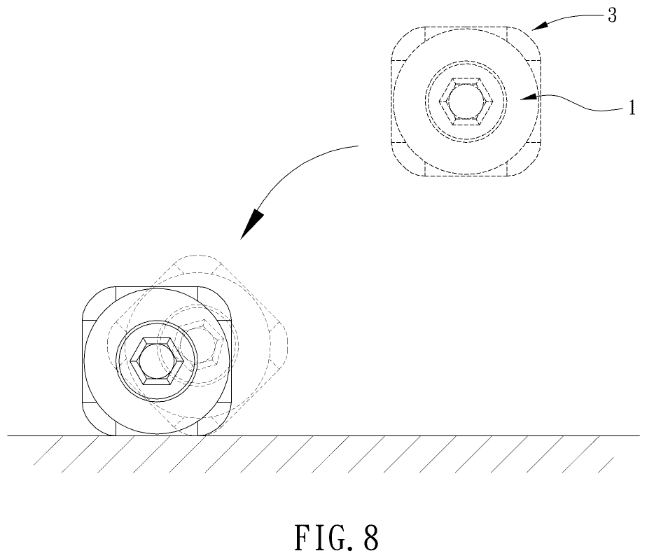

Please refer to FIGS. 1 to 8 for an exemplary embodiment of the present invention. A socket of the present invention includes a main body 1 and a buffer ring 2.

The main body 1 defines a circumferential direction 51, a radial direction 52 and an axial direction 53, the main body 1 includes an outer wall 11 and a plurality of grooves 12, the plurality of grooves 12 are disposed on the outer wall 11 in the radial direction 52, and a plurality of abutting portions 16 each are formed between two neighboring ones of the plurality of grooves 12 in the circumferential direction 51. The buffer ring 2 is sleeved to the outer wall 11 in the axial direction 53 and deformed to be a geometric polygon 3, the geometric polygon 3 includes a plurality of engaging portions 31 and a plurality of corner portions 32, the plurality of engaging portions 31 are engaged in the gap 12, and the plurality of corner portions 32 are abutted on the abutting portion 16. Preferably, in the radial direction 52 each of the plurality of engaging portions 31 projects beyond one of the plurality of grooves 12 so that it provides the whole protection in the circumferential direction 51.

In this embodiment, the buffer ring 2 has a circular radial cross-section, which is conducive to assembling and disassembling the main body 1; the buffer ring 2 is removable from the main body 1, which is conducive to replacement; and the main body 1 may be assembled with the buffer ring 2 in one of various colors, which is advantageous for quickly identifying the size and classifying the socket.

When a collision occurs, the buffer ring 2 sleeved on the outer wall 11 can effectively absorb the impact force to protect the main body 1; and when stored and placed, the socket can be kept spaced apart from adjacent objects by means of the buffer ring 2, to reduce wear and collision.

The buffer ring 2 is circular when not assembled on the outer wall 11. When the buffer ring 2 is sleeved on the outer wall 11, it is deformed into the geometric polygon 3 due to the plurality of engaging portions 31 and the plurality of corner portions 32. When the socket falls to the ground, the geometric polygon 3 can not only absorb shock and buffer, but also effectively prevent the socket from rolling, allowing the user to quickly pick it up.

Preferably, a friction coefficient of the buffer ring 2 is larger than a friction coefficient of the main body 1, which effectively prevents the socket from rolling. In this embodiment, the buffer ring 2 is made of rubber, and the main body 1 is made of metal.

Specifically, the main body 1 is tubular, each of the plurality of grooves 12 extends straightly, and each of the plurality of abutting portions 16 is an arcuate convex protrusion. The main body 1 further includes a connection hole 17 and a driving hole 18, the connection hole 17 is polygonal and configured to be connected to a driving tool, the driving hole 18 is polygonal and configured to be connected to a driven member, the number of the plurality of grooves 12 is equal to the number of sides of the driving hole 18, and the plurality of grooves 12 are parallel to the sides of the driving hole 18, respectively. As such, the geometric polygon 3 and the driving hole 18 are in similar shapes so that the user can know the shape of the driving hole 18 by looking at the shape of the geometric polygon 3. In this embodiment, the plurality of grooves includes four grooves 12, the plurality of abutting portions includes four abutting portions 16, as viewed in the axial direction 53, the four grooves 12 are located on sides of a rectangle, and the four abutting portions 16 are located on corners of the rectangle.

Specifically, each of the plurality of grooves 12 includes a bottom side 13 and two lateral sides 14, the two lateral sides 14 are respectively disposed at opposing ends of the bottom side 13 in the axial direction 53, each of the two lateral sides 14 and the bottom side 13 define an included angle 15 therebetween, and the included angle 15 is larger than or equal to 90 degrees. Each of the plurality of engaging portions 31 is abutted on the bottom side 13 and the two lateral sides 14 of one of the plurality of grooves 12. As such, the engaging portion 31 can contact with the groove 12 in three different directions, thereby improving the stability of the engagement portion 31 and the groove 12, which prevents the engaging portion 31 from disengaging from the groove 12.

Preferably, the included angle 15 is larger than 90 degrees so that, in the axial direction 53, between each of the plurality of engaging portions 31 and each of the two lateral sides 14 is a gap 4. To remove the buffer ring 2, the user can insert the finger(s) or tool into the gap 4 to take the engaging portion 31 out of the groove 12.

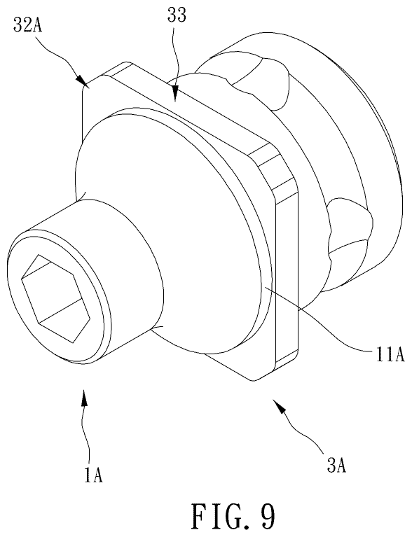

Please refer to FIG. 9 for another embodiment. The socket includes the main body 1A and the geometric polygon 3A. The main body 1A includes the outer wall 11A, the geometric polygon 3A and the main body 1A are integrally formed of one piece and in a stepped configuration, and the geometric polygon 3A projects from the outer wall. The socket may be formed of one piece through various processing methods such as forging, turning, etc. In this embodiment, the main body 1A tubular, the geometric polygon 3A is a rectangular plate, the geometric polygon 3A includes a plurality of the corner portions 32A and a plurality of connection portions 33, the plurality of connection portions 33 are connected between two neighboring ones of the plurality of corner portions 32A, respectively. An extent of each of the plurality of the corner portions 32A from the outer wall 11A is larger than an extent of each of the plurality of connection portions 33 from the outer wall 11A.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A socket including:
a main body defining a circumferential direction, a radial direction and an axial direction, and including an outer wall and a plurality of grooves, the plurality of grooves being disposed on the outer wall and extending in the radial direction, a plurality of abutting portions each being formed between two neighboring ones of the plurality of grooves in the circumferential direction; and
a buffer ring sleeved to the outer wall in the axial direction and deformed to be a geometric polygon, the geometric polygon including a plurality of engaging portions and a plurality of corner portions, the plurality of engaging portions being engaged in the plurality of grooves, the plurality of corner portions being abutted on the plurality of abutting portions.

2. The socket of claim 1, wherein the main body is tubular, each of the plurality of grooves extends straightly, and each of the plurality of abutting portions is a convex protrusion.

3. The socket of claim 2, wherein the main body further includes a connection hole and a driving hole, the connection hole is polygonal and configured to be connected to a driving tool, the driving hole is polygonal and configured to be connected to a driven member, the number of the plurality of grooves is equal to the number of sides of the driving hole, and the plurality of grooves are parallel to the sides of the driving hole, respectively.

4. The socket of claim 2, wherein the plurality of grooves includes four grooves, the plurality of abutting portions includes four abutting portions, as viewed in the axial direction, the four grooves are located on sides of a rectangle, and the four abutting portions are located on corners of the rectangle.

5. The socket of claim 1, wherein a friction coefficient of the buffer ring is larger than a friction coefficient of the main body.

6. The socket of claim 5, wherein the buffer ring is made of rubber, and the main body is made of metal.

7. The socket of claim 1, wherein each of the plurality of grooves includes a bottom side and two lateral sides, the two lateral sides are respectively disposed at opposing ends of the bottom side in the axial direction, each of the two lateral sides and the bottom side define an included angle therebetween, and the included angle is larger than or equal to 90 degrees.

8. The socket of claim 7, wherein each of the plurality of engaging portions is abutted on the bottom side and the two lateral sides of one of the plurality of grooves.

9. The socket of claim 3, wherein the plurality of grooves includes four grooves, the plurality of abutting portions includes four abutting portions, as viewed in the axial direction, the four grooves are located on sides of a rectangle, and the four abutting portions are located on corners of the rectangle; a friction coefficient of the buffer ring is larger than a friction coefficient of the main body; the buffer ring is made of rubber, and the main body is made of metal; each of the plurality of grooves includes a bottom side and two lateral sides, the two lateral sides are respectively disposed at opposing ends of the bottom side in the axial direction, each of the two lateral sides and the bottom side define an included angle therebetween, and the included angle is larger than or equal to 90 degrees; each of the plurality of engaging portions is abutted on the bottom side and the two lateral sides of one of the plurality of grooves; the buffer ring has a circular radial cross-section, and the buffer ring is removable from the main body; each of the plurality of engaging portions projects beyond one of the plurality of grooves in the radial direction; in the axial direction, between each of the plurality of engaging portions and each of the two lateral sides is a gap.

10. A socket including:
a main body including an outer wall; and
a geometric polygon, the geometric polygon and the main body being integrally formed of one piece, the geometric polygon projecting from the outer wall.
